(19) United States
(12) Patent Application Publication
(10) Pub. No.: US 2005/0143139 A1
(43) Pub. Date: Jun. 30, 2005

(54) Method for controlling mobile phone to output audio signals and alert sounds through external audio player

(75) Inventors: Tae-Won Park, Chilgok-gun (KR); Hark-Sang Kim, Seo-gu (KR); Seok-Hyo Park, Gumi-si (KR); Byung-Hwan Suh, Chilgok-gun (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/024,448

(22) Filed: Dec. 30, 2004

(30) Foreign Application Priority Data
Dec. 31, 2003 (KR) 2003-101756

(51) Int. Cl. H04M 1/00

(52) U.S. Cl. 455/567; 455/418

(57) ABSTRACT

Disclosed is a method of controlling a mobile phone capable of processing incoming call signals, alert sounds and speech signals from a caller, comprising setting modes to be implemented in an audio signal sending mode for outputting audio signals and alert sounds to an external audio player equipped with a radio, modulating an audio signal or an alert sound generated during a mode implemented in the audio signal sending mode to a wireless signal having a predetermined frequency and sending the modulated signal or sound to the radio in the external audio player, and outputting an audio signal or an alert sound generated during a mode that is not implemented in the audio signal sending mode through a speaker of the mobile phone.

### PRIORITY

This application claims priority under 35 U.S.C. §119(a) to an application entitled “Method for Controlling Mobile Phone to Output Audio Signals and Alert Sounds through External Audio Player” filed with the Korean Intellectual Property Office on Dec. 31, 2003 and assigned Serial No. 2003-101756, the entire contents of which are expressly incorporated herein by reference.

### BACKGROUND OF THE INVENTION

1. Field of the Invention

The present invention relates to a mobile phone. More particularly, the present invention relates to a method for controlling a mobile phone equipped with an frequency modulation (FM) receiver to output audio signals and various alert sounds through an external audio player.

2. Description of the Related Art

Conventional mobile phones enable users to make or receive a telephone call through a speaker and a microphone mounted therein. Since it is considered dangerous to make or receive a call while driving, an ear-microphone connected to a jack of a mobile phone or a hands-free car kit is generally used.

Recently, with the development of mobile phones having multimedia functions, users can download music files to their own mobile phones. The users can talk and listen to MP3 digital music through mobile phones that have an MP3 player function.

Also, drivers can obtain mapping or direction information through navigation services available on the wireless Internet. Such information is output to a display window and a speaker of a mobile phone.

There exists a limitation in listening to MP3 music, however, when using a conventional mobile phone because the user has to connect an earphone to a speaker or a plug of the mobile phone. In addition, while driving, the user has to connect the earphone to the plug to listen to MP3 music stored in the mobile phone.

When using navigation services, the user can receive voice instructions or information only through the mobile phone's speaker having a low output volume. Although the above problems can be solved by the use of a hands-free kit, it incurs an additional expense and causes trouble to purchase and affix the hands-free kit to a vehicle. In addition, while driving, the user may fail to hear an alert sound output through the speaker of the mobile phone to notify the user of an event (such as an incoming call or a message).

### SUMMARY OF THE INVENTION

Accordingly, the present invention has been made to solve the above-mentioned and other problems occurring in the prior art. It is an object of the present invention to provide a method for controlling a mobile phone to output audio signals such as voice and music through an external audio player.

Another object of the present invention is to provide a method for controlling a mobile phone to output audio signals and alert or ring sounds for incoming calls through a speaker of an external audio player such as a car audio player that can be used as a hands-free kit.

Still another object of the present invention is to provide a method for controlling a mobile phone to output various alert sounds and audio signals generated during navigation services through a speaker of an external audio player such as a car audio player.

Still another object of the present invention is to provide a method for controlling a mobile phone to output event alert sounds through a speaker of a car audio player, thereby enabling a user to hear the sounds while driving.

In order to accomplish the above objects of the present invention, there is provided a method according to an embodiment of the present invention of controlling a mobile phone capable of processing incoming call signals, alert sounds and speech signals from a caller, which comprises setting modes to be implemented in an audio signal sending mode for outputting audio signals and alert sounds to an external audio player equipped with a radio, modulating an audio signal or an alert sound generated during a mode implemented in the audio signal sending mode to a wireless signal having a predetermined frequency and sending the modulated signal or sound to the radio in the external audio player and outputting an audio signal or an alert sound generated during a mode that is not implemented in the audio signal sending mode through a speaker of the mobile phone.

In accordance with another aspect of the present invention, there is provided a method for controlling a mobile phone capable of processing incoming call signals, alert sounds and speech signals from a caller, which comprises setting an MP3 mode, an incoming call informing mode, a navigation mode and a hands-free mode that are to be implemented in an audio signal sending mode for outputting audio signals and alert sounds to an external audio player equipped with a radio, modulating, while in the MP3 mode, an audio signal in a reproduced MP3 file to a wireless signal having a predetermined frequency and sending the modulated signal to the radio in the external audio player and in the incoming call information mode, modulating a ring or alert sound generated according to an incoming call signal to a wireless signal having a predetermined frequency and sending the modulated sound to the radio in the external audio player. The method for controlling a mobile phone capable of processing incoming call signals, alert sounds and speech signals from a caller further comprises, modulating, while in the navigation mode, an audio signal in voice information received through navigation services to a wireless signal having a predetermined frequency and sending the modulated signal to the radio in the external audio player, and modulating, while in the hands-free mode, a speech signal from a caller or a recipient to a wireless signal having a predetermined frequency and sending the modulated signal to the radio in the external audio player.

### BRIEF DESCRIPTION OF THE DRAWINGS

The above and other objects, features and advantages of the present invention will be more apparent from the following detailed description taken in conjunction with the accompanying drawings, in which:

FIG. 1 is a view showing the structure of a mobile phone capable of outputting audio signals and alert sounds through an external audio player according to an embodiment of the present invention;

FIG. 2 is a view showing a mobile phone having a switch between the D/A converter and FM transmitter in FIG. 1;

FIG. 3 is a flow chart showing a process of setting a mode for operating a mobile terminal in an audio signal sending mode according to an embodiment of the present invention; and

FIGS. 4A and 4B are flow charts showing a process of controlling a mobile phone to output audio signals and alert sounds through an external audio player according to an embodiment of the present invention.

### DETAILED DESCRIPTION OF THE EXEMPLARY EMBODIMENTS

Hereinafter, exemplary embodiments of the present invention will be described with reference to the accompanying drawings. In addition, in the following description of the present invention, a detailed description of known functions and configurations incorporated herein will be omitted for purposes of conciseness.

An audio signal sending mode refers to a mode of outputting audio signals and alert sounds generated from a mobile phone through a particular FM frequency of an external audio player with an embedded radio. In this mode of outputting audio signals and ringing sounds, an MP3 mode, an incoming call informing mode, a hands-free mode and a navigation mode can be implemented. Also, the external audio player refers to an audio player with an embedded FM radio. Such a setup, for example, can exist in an automobile. The car has the external audio player in the form of the cassette/CD/AM/FM tuner. The user sets the radio to a certain station (one that is generally not used), and the FM signal generated by the device according to an embodiment of the present invention is received by the radio and played locally through the car stereo's speakers.

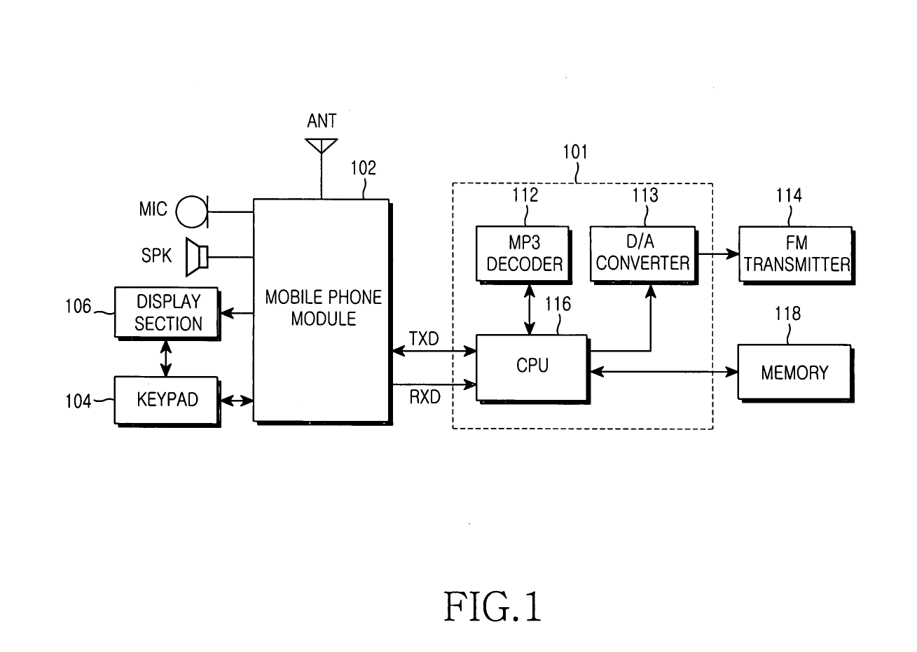

FIG. 1 shows the structure of a mobile phone capable of outputting audio signals and alert sounds through an external audio player according to an embodiment of the present invention. The structure of the mobile phone that outputs audio signals and alert sounds through a speaker of an external audio player will be explained in detail with reference to FIG. 1.

A mobile phone module 102 implements general functions of processing and controlling audio signals for telephone calls or data communications. In the audio signal sending mode selected through a keypad 104, the mobile phone module 102 controls audio signals and alert sounds generated from the mobile phone to be output through an audio player with an FM radio having a particular frequency channel. A detailed explanation of the general telephone function of the mobile phone will be omitted herein.

The mobile phone module 102 stores digital audio data of an MP3 file format that was downloaded upon a user's key input, in a memory 118. The MP3 file can be downloaded via the wireless Internet or via a PC connected to the mobile phone over an RS232 cable connection. The mobile phone module 102 controls overall operations in the audio signal sending mode set through the keypad 104. Depending on whether the mobile phone is in the audio signal sending mode or not, audio signals and alert sounds are output to a CPU 116 or a speaker SPK of the mobile phone. In an MP3 mode set to be implemented in the audio signal sending mode, the mobile phone module 102 receives audio signals in a reproduced MP3 file from the CPU 116. The mobile phone module 102 includes an RF transmitter for performing upward conversion and amplification of the frequency of a signal being transmitted and an RF receiver for amplifying a received signal with low noise and performing downward conversion of the frequency of the signal. In addition, the mobile phone module 102 includes a modem and a codec for modulating and demodulating signals transmitted and received by the RF transmitter and the RF receiver.

A display section 106 receives various information signals from the keypad 104 and the mobile phone module 102 and displays the received signals under the control of the mobile phone module 102. When the audio signal sending mode is set according to an embodiment of the present invention, the display section 106 displays an icon representing the setting of the audio signal sending mode and also displays additional information that is available in the audio signal sending mode.

For example, when the MP3 mode is selected, the display section 106 displays an icon representing the MP3 mode, a title of the MP3 file reproduced in the mode and related file information. When the incoming call informing mode or the hands-free mode is selected, the display section 106 displays a message informing the user of the incoming call, the caller's telephone number and an icon representing the incoming call informing mode or the hands-free mode. When the navigation mode is selected, the display section 106 displays an icon representing the navigation mode and mapping information provided through the navigation services. The display section 106 comprises an liquid crystal display (LCD) and an light emitting diode (LED) that enables the user to see the displayed information even in the dark or at night.

The memory 118 can be comprise of a program memory and a data memory. The program memory stores programs for controlling general operations of the mobile phone and programs for implementing the audio signal sending mode according to an embodiment of the present invention. The data memory temporarily stores data generated during implementation of the above programs. Also, the data memory stores MP3 files received through the mobile phone module 102.

The CPU 116 performs overall operations to receive audio signals and generate alert sounds from the mobile phone from the mobile phone module 102 and transmit the received signals and sounds to an external audio signal with an FM radio. In the MP3 mode, the CPU 116 reads out audio signals from the memory 118 and selectively outputs the audio signals to the mobile phone module 102 or an MP3 decoder 112. When the MP3 mode is set to be implemented in the audio signal sending mode, the CPU 116 outputs the audio signals to an FM transmitter 114. In a general MP3 mode that is not implemented in the audio signal sending mode, the CPU 116 outputs the audio signals read out from the memory 118 to the mobile phone module 102. In any other mode implemented in the audio signal sending mode (such as the incoming call informing mode, hands-free mode or navigation mode), the CPU 116 outputs audio signals and alert sounds to a digital-to-analog (D/A) converter 113. The signal or sound output path is determined depending on whether the audio signal sending mode is set or not. The CPU 116 transmits or receives audio signals and alert sounds to or from the mobile phone module 102. Audio data transmitted and received are depicted as TXD and RXD respectively in FIG. 1.

The MP3 decoder 112 decodes MP3 data received from the CPU 116 and outputs the decoded data. The D/A converter 113 converts a digital audio signal output from the MP3 decoder 112 into an analog signal and outputs the analog signal to the FM transmitter 114 or the speaker SPK of the mobile phone module 102 depending on whether the audio signal sending mode is set or not. In the incoming call informing mode or the hands-free mode, the D/A converter 113 converts audio signals and alert sounds output from the CPU 116 to analog signals and outputs the analog signals. The D/A converter 113 receives a control signal from the CPU 116 to determine an output path according to whether the audio signal sending mode is set or not.

In the MP3, incoming call informing, hands-free or navigation mode set to be implemented in the audio signal sending mode, the FM transmitter 114 performs frequency modulation (FM) on the analog audio signals and alert sounds output from the D/A converter 113 and outputs the modulated signals and sounds. The FM transmitter 114 then modulates the audio signals and alert sounds to a preset frequency channel (which is not used in broadcasting among frequency channels between 88.1 to 108 MHz) and outputs the modulated signals and sounds externally of the mobile phone.

In order to hear the audio signals and alert sounds output from the FM transmitter 114 through an external audio player, the user has to set the audio player (i.e., car stereo) in the FM radio mode having the same frequency bandwidth as the preset frequency channel.

The audio signals and alert sounds output from the mobile phone are transmitted to and received by the external audio player, demodulated and processed, and the audio signals and alert sounds are output through the speaker of the audio player. For example, the mobile phone outputs audio signals and alert sounds in a particular frequency bandwidth to an FM radio in a car (car audio player) in a mode that can be implemented in the audio signal sending mode. The FM radio set in the same frequency bandwidth receives the audio signals and alert sounds output from the mobile phone and outputs them through the car speakers.

The process described above of transmitting audio signals output from the D/A converter to the FM transmitter 114 or the mobile phone module 102 depends on whether the audio signal sending mode is set or not. Alternatively, the mobile phone module 102 can detect whether the audio signal sending mode is set. If the audio signal sending mode is set, the mobile phone module 102 will allow the CPU 116 to control the overall operations of the mobile phone in the audio signal sending mode. Otherwise, the mobile phone module 102 will control the overall operations of the mobile phone.

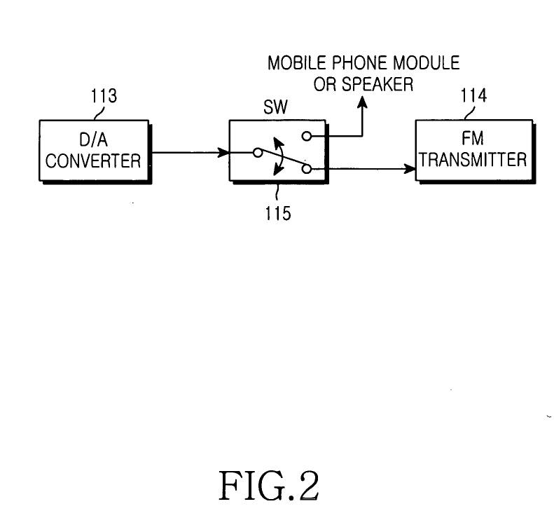

FIG. 2 shows a mobile phone having a switch 115 between the D/A converter and FM transmitter in FIG. 1. Referring to FIG. 2, a switch 115 is provided between the D/A converter 113 and the FM transmitter 114. The switch 115 can selectively output signals from the D/A converter 113 to the FM transmitter 114 or the speaker of the mobile phone according to a switching control signal (not shown). The switching control signal is output from either the mobile phone module 102 or the CPU 116 depending on whether the audio signal sending mode is set or not.

The CPU 116, MP3 decoder 112 and D/A converter 113 of the mobile phone can be incorporated into a single multimedia chip 101 for processing multimedia data. For the operations and functions as explained above, the MP3 mode, incoming call informing mode, hands-free mode and navigation mode should be set in the audio signal sending mode.

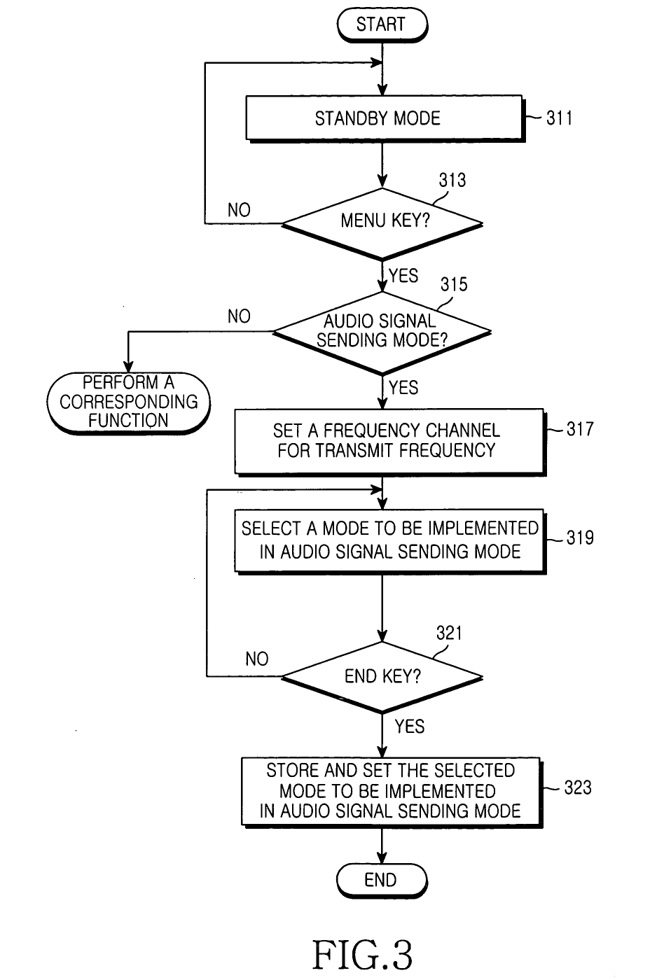

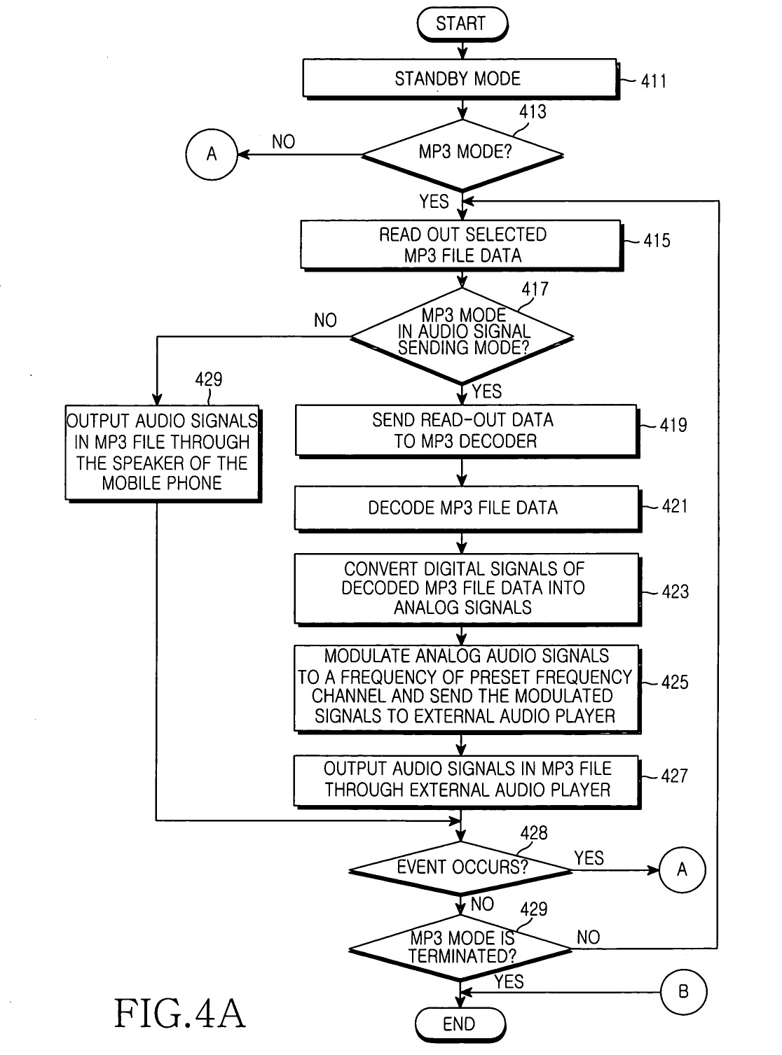

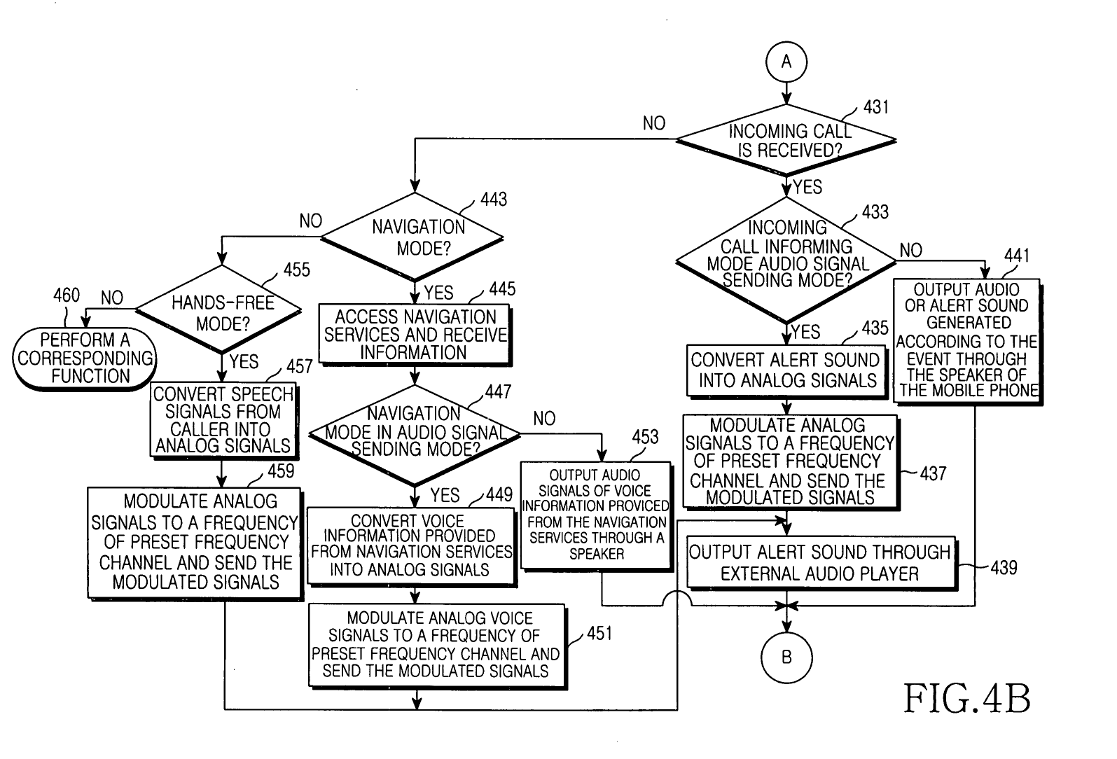

The process for setting a mode for operating a mobile phone in the audio signal sending mode according to an embodiment of the present invention will be explained in detail with reference to FIGS. 3 and 4. FIG. 3 is a flow chart showing a process of setting a mode for operating the mobile phone in the audio signal sending mode according to according to an embodiment of the present invention. FIG. 4 is a flow chart showing a process of controlling a mobile phone to output audio signals and alert sounds through an external audio player according to according to an embodiment of the present invention.

Referring to FIG. 3, the mobile phone module 102 in a standby mode at step 311 proceeds with decision step 313 to detect whether a menu key has been pressed. When the menu key is pressed (“Yes” path from decision step 313), a predetermined number of menus provided on the mobile phone are displayed on the display section 106.

At step 315, the mobile phone module 102 determines whether the user has selected the menu “Audio Signal Sending Mode” using either a combination of a direction key and an OK key or a number key 4. If any other menu is selected, the mobile phone module 102 will perform the function corresponding to the selected menu. If the menu “4” or “Audio Signal Sending Mode” is selected (“Yes” path from decision step 315), the mobile phone module 102 will proceed with step 317 to set a frequency channel of a transmit frequency output through the FM transmitter 114 in the audio signal sending mode as shown in step 437 of FIG. 4B. The frequency channel can be a channel which is not used in broadcasting among frequency channels between 88.1 to 108 MHz.

Subsequently, the mobile phone module 102 proceeds with step 319 to enable the user to select a mode for operating the mobile phone in the audio signal sending mode. As shown in FIG. 4B, when the user selects at least one of either the MP3 mode, incoming call informing mode, hands-free mode or navigation mode to be implemented in the audio signal sending mode, an indication (for example, “V”) of being in the audio signal sending mode is displayed.

At decision step 321, the mobile phone module 102 determines whether an end key on the keypad 104 has been pressed. If the end key is pressed (“Yes” path from decision step 321), the mobile phone module 102 proceeds with step 323 to store the selected mode in the memory 118 and set the mobile phone to operate according to the selected mode. The mobile phone set in the audio signal sending mode through the process as shown in FIG. 3 then performs the process of implementing the audio signal sending mode as described in reference to FIGS. 4A and 4B.

FIGS. 4A and 4B are flow charts showing a process of controlling a mobile phone to output audio signals and alert sounds through an external audio player according to an embodiment of the present invention. Referring to FIG. 4A, the mobile phone module 102 starts in the standby mode at step 411 and determines whether the MP3 mode has been selected at decision step 413.

If the MP3 mode is selected (“Yes” path from decision step 413), the mobile phone module 102 will allow the CPU 116 to control overall operations in that mode. Accordingly, at step 415, the CPU 116 detects an MP3 file selected by the user and reads out the MP3 file from the memory 118.

In order to select an output path of the read-out MP3 file, the mobile phone module 102 determines whether the selected MP3 mode is set to be implemented in the audio signal sending mode at decision step 417. If the selected MP3 mode is to be implemented in the audio signal sending mode (“Yes” path from decision step 417), the CPU 116 will send the MP3 file data to the MP3 decoder 112 at step 419.

The MP3 decoder 112 then decodes the received MP3 file data at step 421 and converts the digital signals in the MP3 file into analog signals at step 423. The MP3 file data converted into analog signals is input to the FM transmitter 114. At step 425, the analog signals are modulated to a frequency of a preset frequency channel and then transmitted to the external audio player.

At step 427, the MP3 file data modulated to a preset frequency channel is sent to a car audio player, and particularly to an FM radio receiver of the car audio player having the same frequency channel and output through the speakers in the car.

At step 429, the mobile phone module 102 determines whether any event occurs or not. Herein, when an event occurs, the mobile phone module 102 proceeds to step 431 of FIG. 4B, otherwise, proceeds to step 429. At step 429, the mobile phone module 102 determines whether a MP3 mode is terminated by a user or not. If a MP3 mode is not terminated, the mobile phone module 102 proceeds to the step 415 and repeats the above-mentioned procedure. If a MP3 mode is terminated, the procedure is ended.

If the selected MP3 mode is determined not to be implemented in the audio signal sending mode at step 417 (“No” path from decision step 417), the mobile phone module 102 will recognize the selected mode as a general MP3 mode and will output the audio signals in the reproduced MP3 file through the speaker SPK of the mobile phone at step 429. Several methods are available to output the audio signals in the MP3 file through the speaker SPK. A first method is to send the MP3 file data read out from the memory 118 to the mobile phone module 102 and output the MP3 file data using a general MP3 reproduction method. A second method is to send the MP3 file data converted into analog signals by the D/A converter 113 to the CPU 116 and then to the mobile phone module 102 to reproduce the MP3 file data. A third method is to directly output the signals output from the D/A converter 113 to the mobile phone module 102 or the speaker SPK through a switch SW to reproduce the MP3 file data.

If the MP3 mode is not detected at step 413 (“No” path from decision step 413) or an event is detected at step 428, the mobile phone module 102 will detect whether any event (such as an incoming call or a message) has occurred at step 431 as shown in FIG. 4B.

Referring to FIG. 4B, when any event is detected (“Yes” path from decision step 431), the mobile phone module 102 determines whether the incoming call informing mode to be implemented in the audio signal sending mode has been selected at decision step 433. If so (“Yes” path from decision step 433), the mobile phone module 102 will proceed with step 435 to convert an alert sound for an incoming call into an analog ring sound through the D/A converter 113.

The analog ring sound is input to the FM transmitter 114 and modulated to a frequency of the preset frequency channel at step 437. The modulated ring sound is then transmitted to the external audio player. The alert sound notifying the user of an incoming call can be a simple ring sound or a voice signal informing that an incoming call is received. When a new message has arrived, the mobile phone can alert the user of the new message by generating a simple alert sound or a voice signal.

At step 439, the MP3 file data modulated to the preset frequency channel is received by the FM radio receiver of the car audio player having the same frequency channel and output through the car speakers. If the selected incoming call informing mode is determined not to be implemented in the audio signal sending mode at decision step 433 (“No” path from decision step 433), the mobile phone module 102 will recognize the selected mode as a general incoming call informing mode and will output the ring or alert sound or the voice signal to the speaker SPK of the mobile phone at step 441.

If no event is detected at step 431 (“No” path from decision step 431), the mobile phone module 102 will determine whether the navigation mode has been selected at decision step 443. If the navigation mode is selected (“Yes” path from decision step 443), the mobile phone module 102 proceeds with step 445 to access a navigation service available to the mobile phone and receive navigation information.

For example, the user can access the auto navigation service “Nate Drive” to receive location-based information by voice and maps displayed on the mobile phone. At decision step 443, the mobile phone module 102 determines whether the selected navigation mode is to be implemented in the audio signal sending mode. If so, the mobile phone module 102 will proceed with step 445 to access Nate Drive available to the mobile phone and receive mapping or direction information.

Graphics information offered by Nate Drive is displayed on the display section 106 through the mobile phone module 102. In addition, voice information is selectively output through the car audio player or the speaker SPK of the mobile phone, depending on whether the navigation mode is set to be implemented in the audio signal sending mode. At decision step 447, the mobile phone module 102 determines whether the navigation mode is to be implemented in the audio signal sending mode. If so (“Yes” path from decision step 447), the mobile phone module 102 will proceed with step 449 to convert the voice information received from the navigation services into analog audio signals through the D/A converter 113.

At step 451, the FM transmitter 114 modulates the analog audio signals to a frequency of the preset frequency channel and sends the modulated signals to the external audio player. The audio signals output from the FM transmitter 114 are received by the FM radio receiver of the car audio player having the same frequency channel and output through the car speakers.

If the selected navigation mode is determined not to be implemented in the audio signal sending mode at step 447 (“No” path from decision step 447), the mobile phone module 102 will recognize the selected mode as a general navigation mode and will output the audio signals of the voice information provided from the navigation services through the speaker SPK of the mobile phone at step 453. If the navigation mode is not detected at decision step 443 (“No” path from decision step 443), the mobile phone module 102 will detect whether the hands-free mode has been selected at step 455. Incoming calls in the hands-free mode can be attended after implementation of steps 433 through 441.

When the hands-free mode is detected (“Yes” path from decision step 455), the mobile phone module 102 converts speech signals from the caller into analog signals through the D/A converter 113 at step 457. At step 459, the FM transmitter 114 modulates the analog signals to a frequency of the preset frequency channel and sends the modulated signals to the FM radio of the car audio player. If, however, the hands free mode is not detected in decision step 455 (“No” path from decision step 455), the method proceeds to step 460 and performs a corresponding function. Following steps 453, 439 and 441, the method proceeds to “B” and returns to the method according to an embodiment of the present invention as shown and described in reference to FIG. 4A.

The FM radio receiver outputs the signals received from the FM transmitter 114 through the car speakers. As explained above, a mobile phone capable of generating audio signals and alert sounds and a method for controlling the mobile terminal according to the embodiments of the present invention can send audio signals and alert sounds generated in the MP3 mode, the incoming call informing, or the hands-free or navigation mode implemented in the audio signal sending mode to an external audio player with an embedded FM radio in order to output the audio signals and the alert sounds through the speaker of the external audio player.

When an event (such as an incoming call or a message) occurs during the reproduction of an MP3 file in the MP3 mode, the mobile phone suspends reproduction of the MP3 file and outputs an alert sound notifying the user of the event. When the incoming call receiving mode is terminated, the mobile phone resumes the reproduction of the MP3 file.

The MP3 mode, incoming call informing mode, hands-free mode and navigation modes have been explained as modes that can be set in the audio signal sending mode. Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

According to the embodiments of the present invention, a low sound output from a mobile phone is modulated to an audio signal in a preset frequency bandwidth and then sent to an external audio player with an embedded FM radio. The audio signal is output through a high-output speaker of the external audio player, thereby enabling the user to hear the audio signal while driving.

MP3 music reproduced in the mobile phone can be modulated to audio signals in a preset frequency bandwidth and output through the external audio player. Also, speech signals from a caller can be modulated to audio signals in a preset frequency bandwidth and output through the external audio player. Accordingly, the user can talk and listen to MP3 digital music through the external audio player with an FM radio while driving, which eliminates the need to purchase a separate car pack or hands-free kit.

No separate unit such as a car pack need be mounted on the external audio player to listen to MP3 music, thereby improving user convenience. Since audio signals and alert sounds notifying the user of events (such as incoming calls and messages) are output through a high-output speaker of the external audio player, the user cannot fail to listen to music or hear the alert sounds while driving.

1. A method of controlling a mobile phone capable of processing incoming call signals, alert sounds and speech signals from a caller, comprising:
setting modes to be implemented in an audio signal sending mode for outputting audio signals and alert sounds to an external audio player equipped with a radio;
modulating an audio signal or an alert sound generated during a mode implemented in the audio signal sending mode to a wireless signal having a predetermined frequency and sending the modulated signal or sound to the radio in the external audio player; and
outputting an audio signal or an alert sound generated during a mode that is not implemented in the audio signal sending mode through a speaker of the mobile phone.

2. The method as claimed in claim 1, wherein the modes set to be implemented in the audio signal sending mode include an MP3 mode, a hands-free mode, an incoming call informing mode and a navigation mode.

3. The method as claimed in claim 1, wherein the wireless signal is a frequency-modulated audio signal or alert sound.

4. The method as claimed in claim 1, wherein the wireless signal has a frequency which is not used in broadcasting among FM radio frequency bandwidths.

5. The method as claimed in claim 1, wherein the step of setting modes includes:
selecting the audio signal sending mode by pressing a menu key and setting a frequency channel of a wireless signal;
selecting a mode to be implemented in the audio signal sending mode and detecting whether an end key is pressed; and
when the end key is pressed, storing the mode selected to be implemented in the audio signal sending mode and setting the mobile phone in the selected mode.

6. The method as claimed in claim 1, wherein the step of setting modes to be implemented in an audio signal sending mode comprises:
reading out a selected MP3 file data to be reproduced;
decoding the MP3 file data;
converting a digital signal in the decoded MP3 file data into an analog audio signal; and
modulating the analog audio signal to a wireless signal having a predetermined frequency and sending the modulated signal to the radio of the external audio player.

7. The method as claimed in claim 1, wherein the step of setting modes to be implemented in an audio signal sending mode comprises:
detecting an event such as an incoming call and converting an alert sound for the event into an analog signal; and
modulating the analog signal to a wireless signal having a predetermined frequency and sending the modulated signal to the radio of the external audio player.

8. The method as claimed in claim 1, wherein the step of setting modes to be implemented in an audio signal sending mode comprises:
accessing a navigation service and receiving information;
converting an audio signal included in received voice information into an analog audio signal; and
modulating the analog audio signal to a wireless signal having a predetermined frequency and sending the modulated signal to the radio of the external audio player.

9. The method as claimed in claim 1, wherein the step of setting modes to be implemented in an audio signal sending mode comprises:
modulating a speech signal from a caller or a recipient, during implementation of a hands-free mode in the audio signal sending mode, to a wireless signal having a predetermined frequency; and
sending the modulated signal to the radio in the external audio player.

10. A method for controlling a mobile phone capable of processing incoming call signals, alert sounds and speech signals from a caller, comprising:
setting an MP3 mode, an incoming call informing mode, a navigation mode and a hands-free mode which are to be implemented in an audio signal sending mode for outputting audio signals and alert sounds to an external audio player equipped with a radio;
in the MP3 mode, modulating an audio signal in a reproduced MP3 file to a wireless signal having a predetermined frequency and sending the modulated signal to the radio in the external audio player;
in the incoming call information mode, modulating a ring or alert sound generated according to an incoming call signal to a wireless signal having a predetermined frequency and sending the modulated sound to the radio in the external audio player;
in the navigation mode, modulating an audio signal in voice information received through navigation services to a wireless signal having a predetermined frequency and sending the modulated signal to the radio in the external audio player; and
in the hands-free mode, modulating a speech signal from a caller or a recipient to a wireless signal having a predetermined frequency and sending the modulated signal to the radio in the external audio player.

11. The method as claimed in claim 10, wherein the wireless signal has a frequency which is not used in broadcasting among FM radio frequency bandwidths.

12. A computer readable medium of instructions for controlling a mobile phone capable of processing incoming call signals, alert sounds and speech signals from a caller, comprising:
a first set of instructions, adapted to set modes to be implemented in an audio signal sending mode for outputting audio signals and alert sounds to an external audio player equipped with a radio;
a second set of instructions, adapted to modulate an audio signal or an alert sound generated during a mode implemented in the audio signal sending mode to a wireless signal having a predetermined frequency and sending the modulated signal or sound to the radio in the external audio player; and
a third set of instructions, adapted to output an audio signal or an alert sound generated during a mode that is not implemented in the audio signal sending mode through a speaker of the mobile phone.

13. The computer readable medium of instructions as claimed in claim 12, wherein said modes set to be implemented in the audio signal sending mode include an MP3 mode, a hands-free mode, an incoming call informing mode and a navigation mode.

14. The computer readable medium of instructions as claimed in claim 12, wherein said wireless signal is a frequency-modulated audio signal or alert sound.

15. The computer readable medium of instructions as claimed in claim 12, wherein said wireless signal has a frequency which is not used in broadcasting among FM radio frequency bandwidths.

16. The computer readable medium of instructions as claimed in claim 12, wherein the first set of instructions adapted to set modes to be implemented in an audio signal sending mode includes:
a fourth set of instructions adapted to select the audio signal sending mode by pressing a menu key and setting a frequency channel of a wireless signal;
a fifth set of instructions adapted to select a mode to be implemented in the audio signal sending mode and detecting whether an end key is pressed; and
a sixth set of instructions adapted to, when the end key is pressed, store the mode selected to be implemented in the audio signal sending mode and setting the mobile phone in the selected mode.

17. The computer readable medium of instructions as claimed in claim 12, wherein the first set of instructions adapted to set modes to be implemented in an audio signal sending mode comprises:
a seventh set of instructions adapted to read out a selected MP3 file data to be reproduced;
an eighth set of instructions adapted to decode the MP3 file data;
a ninth set of instructions adapted to convert a digital signal in the decoded MP3 file data into an analog audio signal; and
a tenth set of instructions adapted to modulate the analog audio signal to a wireless signal having a predetermined frequency and sending the modulated signal to the radio of the external audio player.

18. The computer readable medium of instructions as claimed in claim 12, wherein the first set of instructions, adapted to set modes to be implemented in an audio signal sending mode comprises:
an eleventh set of instructions adapted to detect an event such as an incoming call and converting an alert sound for the event into an analog signal; and
a twelfth set of instructions adapted to modulate the analog signal to a wireless signal having a predetermined frequency and sending the modulated signal to the radio of the external audio player.

19. The computer readable medium of instructions as claimed in claim 12, wherein the first set of instructions, adapted to set modes to be implemented in an audio signal sending mode comprises:
a thirteenth set of instructions adapted to access a navigation service and receiving information;
a fourteenth set of instructions adapted to convert an audio signal included in received voice information into an analog audio signal; and
a fifteenth set of instructions adapted to modulate the analog audio signal to a wireless signal having a predetermined frequency and sending the modulated signal to the radio of the external audio player.

20. The computer readable medium of instructions as claimed in claim 12, wherein the first set of instructions, adapted to set modes to be implemented in an audio signal sending mode comprises:
a sixteenth set of instructions adapted to modulate a speech signal from a caller or a recipient, during implementation of a hands-free mode in the audio signal sending mode, to a wireless signal having a predetermined frequency; and
a seventeenth set of instructions adapted to send the modulated signal to the radio in the external audio player.

21. A computer readable medium of instructions for controlling a mobile phone capable of processing incoming call signals, alert sounds and speech signals from a caller, comprising:
a first set of instructions adapted to set an MP3 mode, an incoming call informing mode, a navigation mode and a hands-free mode which are to be implemented in an audio signal sending mode for outputting audio signals and alert sounds to an external audio player equipped with a radio;
a second set of instructions adapted to, in the MP3 mode, modulate an audio signal in a reproduced MP3 file to a wireless signal having a predetermined frequency and sending the modulated signal to the radio in the external audio player;
a third set of instructions adapted to, in the incoming call information mode, modulating a ring or alert sound generated according to an incoming call signal to a wireless signal having a predetermined frequency and sending the modulated sound to the radio in the external audio player;
a fourth set of instructions adapted to, in the navigation mode, modulating an audio signal in voice information received through navigation services to a wireless signal having a predetermined frequency and sending the modulated signal to the radio in the external audio player; and
a fifth set of instructions adapted to, in the hands-free mode, modulating a speech signal from a caller or a recipient to a wireless signal having a predetermined frequency and sending the modulated signal to the radio in the external audio player.

22. The computer readable medium of instructions as claimed in claim 21, wherein said wireless signal has a frequency which is not used in broadcasting among FM radio frequency bandwidths.
